(19) United States
(12) Patent Application Publication
(10) Pub. No.: US 2009/0250920 A1
(43) Pub. Date: Oct. 8, 2009

(54) Security device for security substrates

(75) Inventors: Roland Isherwood, Hampshire (GB); David Stewart Clinch, Wiltshire (GB)

Correspondence Address: OHLANDT, GREELEY, RUGGIERO & PERLE, LLP, ONE LANDMARK SQUARE, 10TH FLOOR, STAMFORD, CT, 06901, US

(73) Assignee: De La Rue International Limited

(21) Appl. No.: 11/991,302

(22) PCT Filed: Sep. 21, 2006
(86) PCT No.: PCT/GB2006/003512

§ 371 Date: Feb. 29, 2008

(30) Foreign Application Priority Data
Sep. 30, 2005 (GB) 0519975.7

(51) Int. Cl. B42D 15/10; D21H 21/42

(52) U.S. Cl. 283/91; 283/85; 283/110

(57) ABSTRACT

The invention relates to a security device for security substrates, such as paper, used for making security documents, such as bank notes, having anti-counterfeitable features. The security device comprises a carrier of an at least partially light transmitting polymeric material, said carrier being provided with indicia. The indicia comprise a first component being at least one non-alphanumeric pattern which repeats along the length of the device and is formed from at least one fine line, and a second component being alphanumeric characters, the two components being registered to and interlinked with each other.

The invention relates to a security device for security substrates, such as paper, used for making security documents, such as bank notes, having anti-counterfeitable features.

It is generally known to include elongate elements in paper or other substrates, usually as a security feature. Such elements can be threads, strips or ribbons of, for example, plastics film, metal foil, metallised plastic, metal wire. These elongate elements are included in the thickness of the substrate to render imitation of documents produced therefrom more difficult. These elements help in the verification of the documents as they render the view of the documents in reflected light different from that in transmitted light. To increase the security provided by the inclusion of such an elongate element, it is also known to endow the element itself with one or more verifiable properties over and above its presence or absence. Such additional properties include magnetic properties, electrical conductivities, the ability to absorb x-rays, fluorescence, optically variable effects and thermochromic behaviour.

As a further security feature, it has been found to be particularly advantageous to provide windows in one side of the surface of the substrate, which expose such elongate elements at spaced locations. Examples of methods of manufacturing paper incorporating security elements with or without windows are described below. It should be noted that references to “windowed thread paper” include windowed paper incorporating any elongate security element.

EP-A-0059056 describes a method of manufacture of windowed thread paper on a cylinder mould paper-making machine. The technique involves embossing the cylinder mould cover to form raised regions and bringing an impermeable elongate security element into contact with the raised regions of the mould cover, prior to the contact entry point into a vat of aqueous paper stock. Where the impermeable security element makes intimate contact with the raised regions of the embossing, no fibre deposition can occur and windows are formed in the surface of the paper. After the paper is fully formed and couched from the cylinder mould cover, water is extracted from the wet fibre mat and the paper is passed through a drying process. In the finished paper the regions of the security element which are exposed in the windows are visible in reflected light on one side of the paper, which is commonly used for mainly banknotes.

The widespread use of security documents having security elements exposed on windows along the length of the element has resulted in enhanced security. A security document of this type provides this enhancement as, when viewed in transmitted light, the security element provides a different view from that which is seen under reflected light, where parts of the security element are readily visible in the window. However, there is a continual need for further enhanced security features to render the task of a would-be counterfeiter more difficult.

A significant development is described in EP-A-0319157 which describes the incorporation in security paper of a security thread which has a recognisable pattern, design or indicia provided by partially demetallising a metallised carrier substrate. The metal free portions are preferably letters which are clearly visible when the security paper is viewed in transmitted light as strong highlights against a much darker metal background. The indicia can advantageously be legends or numerals relating to the security document itself, e.g. currency value of a banknote.

A further development is described in GB-A-2323814 whereby a security element has a reflective metal layer in the form of a design which consists of at least one repeating geometric pattern of which the frequency, instantaneous amplitude or maximum amplitude of the pattern varies along the length of the element. Such complex fine line patterns are extremely difficult for counterfeiters to generate by the commonly used technique of foil blocking. Additionally it has been found that designs are more easily recognised on a narrow thread than alphanumeric characters which become less legible as they get smaller.

It is an object of the present invention to provide further improved security devices such as threads.

According to the invention there is provided a security device for a security substrate, said device comprising a carrier of an at least partially light transmitting polymeric material, said carrier being provided with indicia, said indicia comprising a first component being at least one non-alphanumeric pattern which repeats along the length of the device and is formed from at least one fine line, said indicia further comprising a second component being alphanumeric characters, the two components being registered to and interlinked with each other.

In one example the profile of the pattern follows the profile of the alphanumeric characters providing a clear link between the two indicia and therefore an easy check for the public.

In another example the pattern includes a series of unit cells in which the alphanumeric characters lie, which form frames around one or more of the alphanumeric characters.

In all examples the function of the pattern is to direct the eye of the public to the alphanumeric characters so the document can be verified. This is particularly useful on narrow security elements where the characters are small and therefore not immediately noticed.

Combining the two components of the indicia increases the aesthetic properties of normal positive or negative alphanumeric designs while making the security device more memorable than one with just a pattern. As a pattern is more aesthetically pleasing than plain alphanumeric characters, it therefore attracts the public eye to the useful alphanumeric identifying information, allowing the security document to be authenticated.

The invention will now be described, by way of Example only, with reference to, and as shown in the accompanying drawings in which:

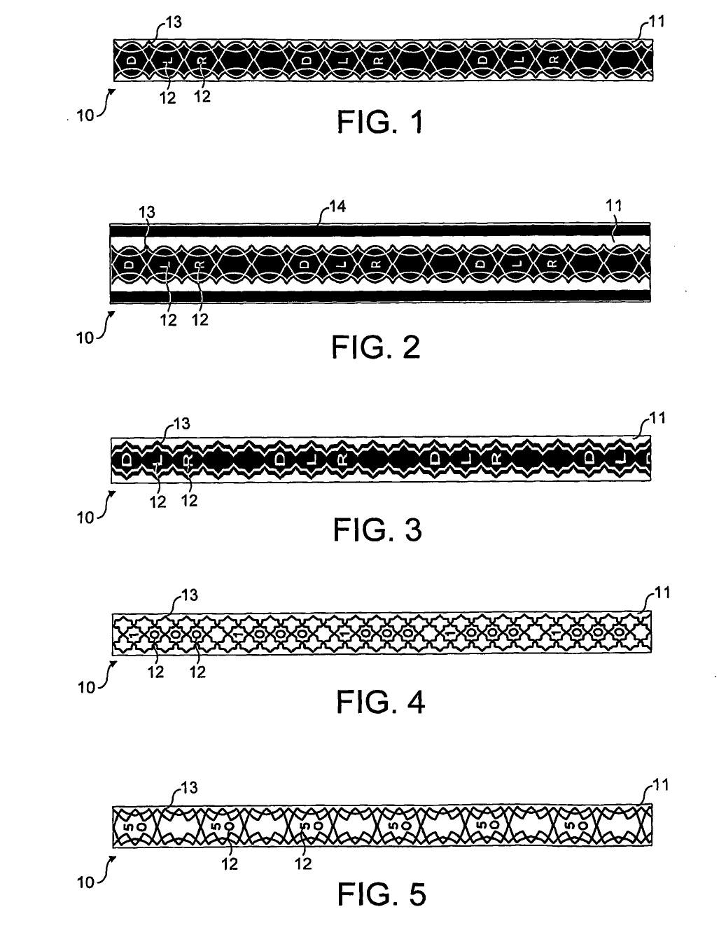

FIGS. 1 to 15 are plan views of sections of alternative security devices according to the present invention.

FIG. 1 shows a section of a security device, in the form of an elongate element 10, according to a first embodiment of the present invention.

Elongate security elements 10, and other security devices, are preferably inserted into a paper, or other fibrous substrate, so that they are either wholly or partially embedded within the substrate. Whilst the security element 10 can be used in wholly embedded or windowed form, the latter is preferred as the indicia are then easily recognisable in both reflected and transmitted light, rather than just transmitted light as in the wholly embedded form. The security devices of the present invention are also particularly suitable for use in a construction as described in EP-A-1141480 in which one side of the device is wholly exposed at one surface of the substrate in which it is partially embedded, and partially exposed in windows at the other surface of the substrate.

The security device of the present invention is also particularly suitable for use in a construction described in EP-A-1536064 in which a protective band is incorporated into a paper web formed on a cylinder mould machine such that windows are formed on protruded elements on the face side of the web. A second paper web is applied to the backside to hide any defects formed as a result of incorporating the protective band.

Alternatively the security devices may be applied to the surface of the substrate, as a strip or patch.

The security element 10 has a base carrier 11 of a suitable plastic material which is flexible and water impermeable, and which is at least translucent and partially light transmissive, but preferably substantially transparent. A suitable material would be polyethyleneterephthalate (PET). The carrier 11 is metallised with aluminium or another suitable metal. This can be done by vacuum deposition, electroplating or another suitable method. The metallised carrier film 11 is partially demetallised using a known method, such as the resist and etch technique, to provide indicia which comprise a combination of a first component comprising a alphanumeric characters 12 and a second component comprising a preferably substantially continuous, repeating fine line pattern 13 along the length of the element 10. The two compounds are in exact registration with each other at all times.

As in GB-A-2323814, the pattern 13 is preferably a geometric pattern in which at least one of the frequency, instantaneous amplitude or maximum amplitude of the geometric pattern varies along the length of the element 10. However, in FIG. 1 the alphanumeric characters 12 lie within regions of the geometric pattern 13 so as to be framed thereby.

FIG. 1 shows an embodiment in which the alphanumeric characters 12 “D”, “L” and “R” are negative metallic text. The pattern 13 is formed by a plurality of fine demetallised lines of which the instantaneous and maximum amplitude varies along the length of the element 10. The fine demetallised lines of the pattern define a series of unit cells of metal in which the alphanumeric characters 12 lie. Thus the demetallised lines frame or outline characters 12, thereby highlighting them. When viewed, the pattern 13 first draws the viewers eye and this provides the first level of anti-counterfeitability and a security test. Once focused on the repeating pattern 13, the viewer's eye is further drawn to the text, which provides the second level of security.

A wide range of legends can be used as the alphanumeric characters 12 including letters, words, numbers, denominations, signatures and the like. Possible characters include those from non-Roman scripts of which examples include but are not limited to, Chinese, Japanese, Sanskrit and Arabic. A wide range of patterns 13 can be used, including patterns formed of single or multiple fine lines such as those described in GB-A-2323814. Preferably the designs are made up of one or more varying geometric patterns, the whole combination of which constitutes the design. The geometric pattern can be created by varying at least one of the frequency, instantaneous amplitude or maximum amplitude of the pattern along the length of the element. Preferably the designs have no straight line boundaries, i.e. the extreme edges of the overall design. Preferably the design also provides a continuous metal path along the length of the element.

The alphanumeric characters 12 may preferably be demetallised and be defined in portions of the pattern 13 which are of metal as shown in FIG. 1. However, the alphanumeric characters 12 may alternatively be formed by metal or metallic ink within clear regions defined or provided by the pattern 13.

The use of a demetallisation technique can mean that there may be a solid metal region 14 outside the pattern 13 formed by the demetallised lines as shown in FIG. 2. Such a design would allow a magnetic feature to be provided in the form of tramlines along the length of the elongate element 10 under the metal regions 14, in a manner such as is described in EP-A-516790.

FIG. 3 is an alternative embodiment of the construction shown in FIG. 1 in which the pattern 13 is formed by two sets of fine demetallised lines and the alphanumeric characters 12 are the demetallised letters “D”, “L” and “R”. In this embodiment the lines of the pattern 13 do not completely surround the text, but the amplitude of the lines within the pattern 13 is varied to enable the characters “D”, “L” and “R” to fit within and be at least partly framed by the clearly defined regions of the pattern 13. The link between the pattern 13 and the text is both obvious and memorable to the general public and difficult to counterfeit because the lines of the pattern 13 must be accurately registered to the text of the alphanumeric characters 12.

FIGS. 4 and 5 show an alternative construction in which the alphanumeric characters 12 are positive metallic numerals (1000) and lie within a pattern 13 formed by a plurality of fine metallic lines. Again the two components of the indicia are interlinked in that the positive characters 12 lie within portions of the pattern 13 so as to be wholly framed and highlighted thereby.

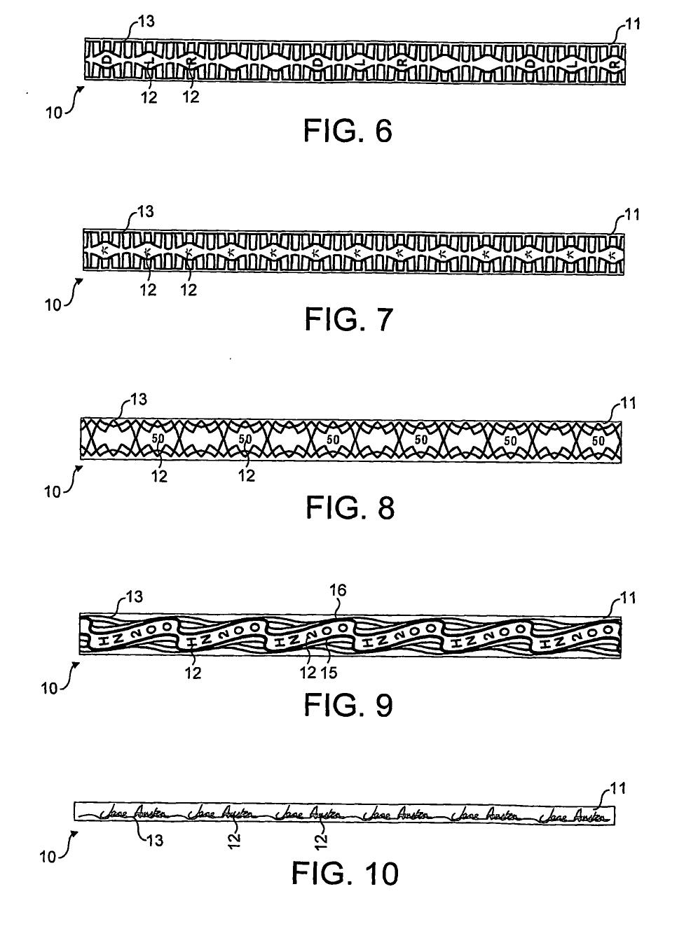

FIG. 6 shows an alternative construction in which the alphanumeric characters “D”, “L” and “R” are positive metallic characters which fit within clearly defined regions of the pattern which are defined by a plurality of fine demetallised lines 13, so as to be partly framed thereby.

FIG. 7 shows a similar constructions to the one shown in FIG. 6. In this embodiment the alphanumeric component 12 of the indicia comprises Chinese characters.

In the examples shown in FIGS. 1 to 6 the alphanumeric characters 12 are oriented such that they read in a vertical direction viewed parallel to the long length of elongate security device 10. However, it is also possible that the characters 12 can be oriented such that they read in a horizontal direction viewed parallel to the short length of the security device 10. FIG. 8 shows an embodiment where the positive metallic characters “5” and “0” are oriented such that they read in a horizontal direction viewed parallel to the short length of the security device 10.

FIG. 9 shows an alternative embodiment in which the alphanumeric characters 12 comprise the text “HN200” and are positive metallic characters and lie within a pattern 13 formed by a plurality of fine metallic lines. In this embodiment the profile and orientation of the text is such that it follows the same path of the fine demetallised lines 15 and 16. This provides a memorable and obvious link between the pattern 13 and the characters 12 and increases the complexity and anti-counterfeiting properties of the security device 10.

FIG. 10 shows an alternative embodiment in which the alphanumeric characters 12 comprise a signature, in this case of “Jane Austen”. The pattern 13 comprises a single fine metallic line that underlines and mimics the profile of the signature. The mimicking of the profile of the signature by the line provides a clear link between the pattern 13 and the alphanumeric characters 12 producing a secure, memorable and complex security device 10.

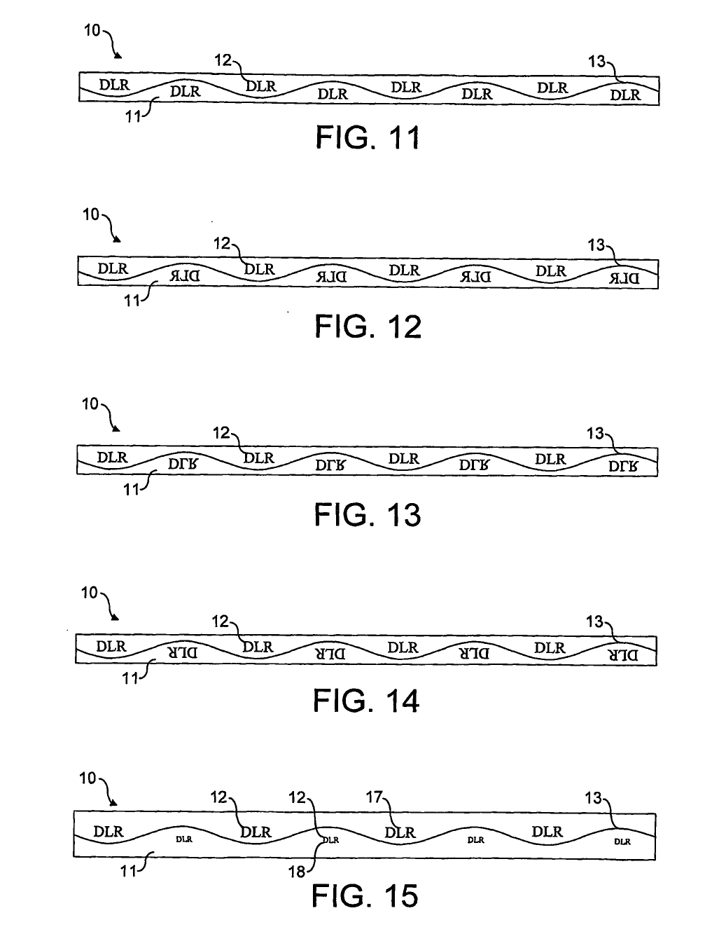

FIG. 11 shows an alternative construction in which the alphanumeric characters “DLR” are positive metallic characters interlinked with a pattern 13 formed by a single fine metallic line. The pattern 13 and the alphanumeric characters are interlinked by the fact that the path of the line is such that it weaves in and out of the alphanumeric characters 12.

FIGS. 11 to 14 show how the orientation of the alphanumeric characters 12 can be varied along the security device 10 to ensure that the identifying information reads correctly when inserted into the final security substrate. The oriented repeating text “DLR”, as shown in FIG. 11, only allows it to be read from one side of the document and at the correct orientation and is suitable for processes where an elongate security device 10 is always incorporated into the base substrate in the same orientation. If the orientation of the security device 10 is not controlled when incorporated into the base substrate the alternative designs in FIGS. 12 to 14 may be employed. The “reversed” repeating text of FIG. 12 enables it to be read from either side of the substrate at the same orientation. The “inversed” repeating text of FIG. 13 enables it to be read from either side of the substrate at opposing orientations. The “inversed and reversed” orientation of FIG. 14 enables the text to be read from one side of the substrate but at opposing orientations.

In the examples shown in FIGS. 1-15 positive characters 12 have been combined with a fine metallised line pattern 13 and negative characters have been combined with a fine demetallised line pattern. However it is also possible to combine negative characters 12 with a fine metallised line pattern 13 and positive characters with a fine demetallised line pattern 13. In addition the nature of the pattern 13 and characters 12 may change along the length of the security element 10 and the characters 12 can include both negative and positive characters and the pattern 13 can include both metallised and demetallised lines.

The identifying information can comprise of characters 12 of different sizes. FIG. 15 shows a construction in which the alphanumeric characters 12 in the form of the letters “DLR” are positive metallic characters interlinked with a pattern 13 formed by a single fine metallic line. The positive metallic characters form a first information region 17 and a second information region 18 where the second information region is harder to resolve visually due to its smaller size compared to the first information region.

The transverse width of the element 10 is preferably greater than or equal to 2.00 mm. Preferably at least one continuous metal path is provided along the length of the device by the pattern 13. The widths of the fine lines defining some of the patterns 13 is preferably in the range of 0.05 mm to 0.15 mm inclusive, and more preferably in the range of 0.05 mm to 0.10 mm.

As an alternative to metallisation and demetallisation, inks, in particular metallic or metal effect inks and more preferably high reflectivity metallic or effect inks, may be deposited on the carrier 11 by a printing technique to form the metal regions. As a further alternate to metal effect inks other optical effect inks can be used e.g. OVI® optically variable inks. Also transparent-coloured or opaque-coloured printing inks can be used.

As another alternative to metallised characters 12 and patterns 13, liquid crystal polymeric films or inks can be used. In this instance it is preferable to combine the liquid crystal materials with a darkly coloured background to enhance the colour shifting effect of the liquid crystal. This can be achieved by printing the characters 12 and patterns 13 using a dark ink and then overprinting a liquid crystal ink e.g. Oasis® ink from SICPA or by application of a polymer liquid crystal film over the fine lines. Another approach would be as described in WO-A-03061980 where a metallised polymeric substrate is demetallised using the resist and etch technique where the resist is black or darkly coloured. A liquid crystal layer is then applied onto this darkly coloured resist.

The present invention may also be combined with other anti-counterfeiting materials, such as thermochromic materials, liquid crystal coatings or films, colourshifting inks, colourshifting interference films, holographic generating structures, luminescent, phosphorescent and fluorescent coatings and inks.

The characters 12 may be registered with windows in the substrate in the machine direction, so that an identical portion is seen in each window. This requires the use of a registration process, such as that described co-pending application GB 0409736.6.

The security devices can be in the form of elongate security elements, as described above, or patches, filaments, threads and the like and can not only be wholly embedded, partially embedded but also applied to the surface of a substrate.

The finished security paper may be printed on one or both sides to identify the article or document formed from the paper. This printing may include alphanumeric characters and/or a pattern which matches those on the security device. The characters and/or pattern on the security device and document may be registered with each other, which would make it very difficult to counterfeit. The security device may have a tinted translucent coat to match the colour of the paper or the printing itself to enhance the visual effect of the metallic pattern.

Alternatively, the substrate may be coloured with a dye to match the printing.

In manufacturing security devices as described above, these are usually made from a web of the base carrier substrate which is then slit or otherwise cut to form individual security devices.

1. A security device for a security substrate, said device comprising a carrier of an at least partially light transmitting polymeric material, said carrier being provided with indicia, said indicia comprising a first component being at least one non-alphanumeric pattern which repeats along the length of the device and is formed from at least one fine line, said indicia further comprising a second component being alphanumeric characters, the two components being registered to and linked with each other, characterized in that a profile of at least one of the fine lines of the pattern mimics a profile of the alphanumeric characters.

2. A security device for a security substrate, said device comprising a carrier of an at least partially light transmitting polymeric material, said carrier being provided with indicia, said indicia comprising a first component being at least one non-alphanumeric pattern which repeats along the length of the device and is formed from at least one fine line, said indicia further comprising a second component being alphanumeric characters, the two components being registered to and linked with each other, characterized in that the pattern defines a series of unit cells in which the alphanumeric characters are framed.

3. The security device as claimed in claim 1, wherein at least one of the frequency, instantaneous amplitude or maximum amplitude of the pattern varies along a length of the device.

4. The security device as claimed in claim 1, wherein the pattern has no straight line boundaries.

5. The security device as claimed in claim 1, wherein the pattern defines a series of interlinked regions in which the alphanumeric characters lie, thereby being partially framed.

6. The security device as claimed claim 1, wherein the pattern is formed from at least one opaque fine line.

7. The security device as claimed in claim 1, wherein the pattern is formed from at least one clear fine line in an opaque background.

8. The security device as claimed in claim 1, wherein the pattern includes opaque regions defined by the fine lines.

9. The security device as claimed in claim 1, wherein the pattern includes clear regions defined by the fine lines.

10. The security device as claimed in claim 1, wherein the characters are opaque.

11. The security device as claimed in claim 1, wherein the alphanumeric characters are clear regions in an opaque background.

12. The security device as claimed in claim 1, wherein the alphanumeric characters comprise a signature.

13. The security device as claimed in claim 1, wherein the pattern provides a continuous metallic path along the length of the security device.

14. The security device as claimed in claim 1, wherein the width of the security device is greater than or equal to 2.0 mm.

15. The security device as claimed as claimed in claim 1, wherein the pattern has a plurality of continuous metal paths.

16. The security device as claimed in claim 1, wherein the pattern is formed from lines in which the widths of at least some of the lines lie in the range 0.05 mm to 0.15 mm inclusive.

17. The security device as claimed in claim 16, wherein the widths of at least some of the lines lie in the range 0.05 mm to 0.10 mm.

18. The security device as claimed in claim 1, wherein the substrate is colourless.

19. The security device as claimed in claim 1, wherein the substrate is coloured.

20. The security device as claimed in claim 1, wherein the security device has a translucent coloured coat.

21. A security substrate comprising a security device as claimed in claim 1 wholly or partially embedded in the substrate.

22. The security substrate as claimed in claim 21, further comprising windows in at least one surface of the substrate at which are exposed regions of the security device.

23. The security substrate as claimed in claim 21, wherein one side of the device is wholly exposed at one surface of the substrate in which it is partially embedded, and partially exposed in windows at the other surface of the substrate.

24. A security substrate comprising a security device as claimed in claim 1, wherein the device is applied to the surface of the substrate.

25. A security article formed from the substrate as claimed in claim 21 comprising printing on at least one surface of the security substrate.

26. The security article as claimed in claim 25, wherein the printing on the surface of the substrate matches the characters and/or pattern.

27. The security article as claimed in claim 25 comprising a banknote.

28-30. (canceled)

31. The security device as claimed in claim 2, wherein at least one of the frequency, instantaneous amplitude or maximum amplitude of the pattern varies along a length of the device.

32. The security device as claimed in claim 2, wherein the pattern has no straight line boundaries.

33. The security device as claimed in claim 2, wherein the pattern is formed from at least one opaque fine line.

34. The security device as claimed in claim 2, wherein the pattern is formed from at least one clear fine line in an opaque background.

35. The security device as claimed in claim 2, wherein the pattern includes opaque regions defined by the fine lines.

36. The security device as claimed in claim 2, wherein the pattern includes clear regions defined by the fine lines.

38. The security device as claimed in claim 2, wherein the characters are opaque.

39. The security device as claimed in claim 2, wherein the alphanumeric characters are clear regions in an opaque background.

40. The security device as claimed in claim 2, wherein the alphanumeric characters comprise a signature.

41. The security device as claimed in claim 2, wherein the pattern provides a continuous metallic path along the length of the security device.

42. The security device as claimed in claim 2, wherein the width of the security device is greater than or equal to 2.0 mm.

43. The security device as claimed in claim 2, wherein the pattern has a plurality of continuous metal paths.

44. The security device as claimed in claim 2, wherein the pattern is formed from lines in which the widths of at least some of the lines lie in the range 0.05 mm to 0.15 mm inclusive.

45. The security device as claimed in claim 44, wherein the widths of at least some of the lines lie in the range 0.05 mm to 0.10 mm.

46. The security device as claimed in claim 2, wherein the substrate is colourless.

47. The security device as claimed in claim 2, wherein the substrate is coloured.

48. The security device as claimed in claim 2, wherein the security device has a translucent coloured coat.

49. A security substrate comprising a security device as claimed in claim 2, wholly or partially embedded in the substrate.

50. The security substrate as claimed in claim 49, further comprising windows in at least one surface of the substrate at which are exposed regions of the security device.

51. The security substrate as claimed in claim 49, wherein one side of the device is wholly exposed at one surface of the substrate in which it is partially embedded, and partially exposed in windows at the other surface of the substrate.

52. A security substrate comprising a security device as claimed in claim 2, wherein the device is applied to the surface of the substrate.

53. A security article formed from the substrate as claimed in claim 49, comprising printing on at least one surface of the security substrate.

54. The security article as claimed in claim 53, wherein the printing on the surface of the substrate matches the characters and/or pattern.

55. The security article as claimed in claim 53, comprising a banknote.
